(19) United States
(12) Patent Application Publication
(10) Pub. No.: US 2023/0309204 A1
(43) Pub. Date: Sep. 28, 2023

(54) ILLUMINATION CONTROL DEVICE, METHOD AND NON-TRANSITORY COMPUTER READABLE MEDIUM STORING ILLUMINATION CONTROL PROGRAM

(71) Applicant: Roland Corporation, Shizuoka (JP)

(72) Inventor: Satoshi Wakuda, Shizuoka (JP)

(73) Assignee: Roland Corporation, Shizuoka (JP)

(21) Appl. No.: 18/188,445

(22) Filed: Mar. 22, 2023

(30) Foreign Application Priority Data
Mar. 25, 2022 (JP) 2022-050561

(51) Int. Cl. H05B 45/12; H05B 47/16; H05B 47/105

(52) U.S. Cl. CPC H05B 45/12; H05B 47/16; H05B 47/105

(57) ABSTRACT

An illumination control device, an illumination control method, and a non-transitory computer readable medium storing an illumination control program are provided. The illumination control device includes a video processor configured to acquire video and a signal processor configured to generate an illumination control signal including a plurality of sets of illumination control values for controlling illumination based on the video acquired by the video processor and to transmit the generated illumination control signal to one or more illumination instruments at intervals of a predetermined period.

### CROSS-REFERENCE TO RELATED APPLICATION

This application claims the priority benefit of Japan application serial No. 2022-050561, filed on Mar. 25, 2022. The entirety of the above-mentioned patent application is hereby incorporated by reference herein and made a part of this specification.

### BACKGROUND

### Technical Field

The disclosure relates to an illumination control device, an illumination control method, and a non-transitory computer readable medium storing an illumination control program.

### Description of Related Art

Patent Document 1 discloses an illumination device mainly including a video and sound reproducing unit 6, an illumination control unit 8, an illumination output unit 9, and a video and sound output unit 10 (such as a television). A video and sound from the video and sound reproducing unit 6 are output to the video and sound output unit 10, and illumination control data based on averaged chromaticity of the video from the video and sound reproducing unit 6 is output to the illumination output unit 9. Accordingly, it is possible to enhance a sense of immersion of a user 4 in the video displayed on the video and sound output unit 10.

The video and sound reproducing unit 6 outputs a frame to the illumination control unit 8 at a predetermined frame rate (for example, 30 FPS). Therefore, it is considered that the illumination control unit 8 generates illumination control data based on a frame input at a timing based on the frame rate and outputs the illumination control data to the illumination output unit 9 at the timing.

[Patent Document 1] Japanese Patent Laid-Open No. 2000-173783 (for example, Paragraphs 0197 to 0205, FIG. 9)

However, some illumination output units 9 may be turned off when illumination control data is not input in a predetermined period. Since processing loads of the illumination control unit 8 and the illumination output unit 9 increase as the frame rate increases, a situation in which the illumination control unit 8 cannot generate illumination control data at the timing based on the frame rate and cannot output the illumination control data to the illumination output unit 9 may occur. That is, there is a problem in that illumination cannot be stably controlled.

### SUMMARY

The disclosure provides an illumination control device, an illumination control method, and a non-transitory computer readable medium storing an illumination control program.

An illumination control device according to the disclosure includes: a video processor configured to acquire video; and a signal processor configured to generate an illumination control signal including a plurality of sets of illumination control values for controlling illumination based on the video acquired by the video processor and to transmit the generated illumination control signal to one or more illumination instruments at intervals of a predetermined period.

A non-transitory computer readable medium according to the disclosure stores an illumination control program. The illumination control program causes a computer to perform an illumination control process. The illumination control program causes the computer to perform: acquiring video; generating an illumination control signal including a plurality of sets of illumination control values for controlling illumination based on the acquired video; and transmitting the generated illumination control signal to one or more illumination instruments at intervals of a predetermined period.

An illumination control method according to the disclosure includes: acquiring video; generating an illumination control signal including a plurality of sets of illumination control values for controlling illumination based on the acquired video; and transmitting the generated illumination control signal to one or more illumination instruments at intervals of a predetermined period.

### BRIEF DESCRIPTION OF THE DRAWINGS

FIG. 1 is a diagram illustrating an outline of an illumination control device according to an embodiment.

FIG. 2(a) is a diagram illustrating screen sections and FIG. 2(b) is a diagram illustrating color modes.

FIG. 3 is a block diagram illustrating an electrical configuration of the illumination control device.

FIG. 4(a) is a diagram schematically illustrating a section color information table and FIG. 4(b) is a diagram schematically illustrating an illumination setting table.

FIG. 5 is a functional block diagram of the illumination control device.

FIG. 6(a) is a flowchart illustrating video processing which is performed by a video processing unit (a video processor) and FIG. 6(b) is a flowchart illustrating sound processing which is performed by a sound processing unit (a sound processor).

FIG. 7 is a flowchart illustrating a main process which is performed by a CPU implemented as a signal processor.

FIG. 8 is a flowchart illustrating a section color setting process.

FIG. 9(a) is a flowchart illustrating a white extracting process and FIG. 9(b) is a flowchart illustrating a flash adding process.

### DESCRIPTION OF THE EMBODIMENTS

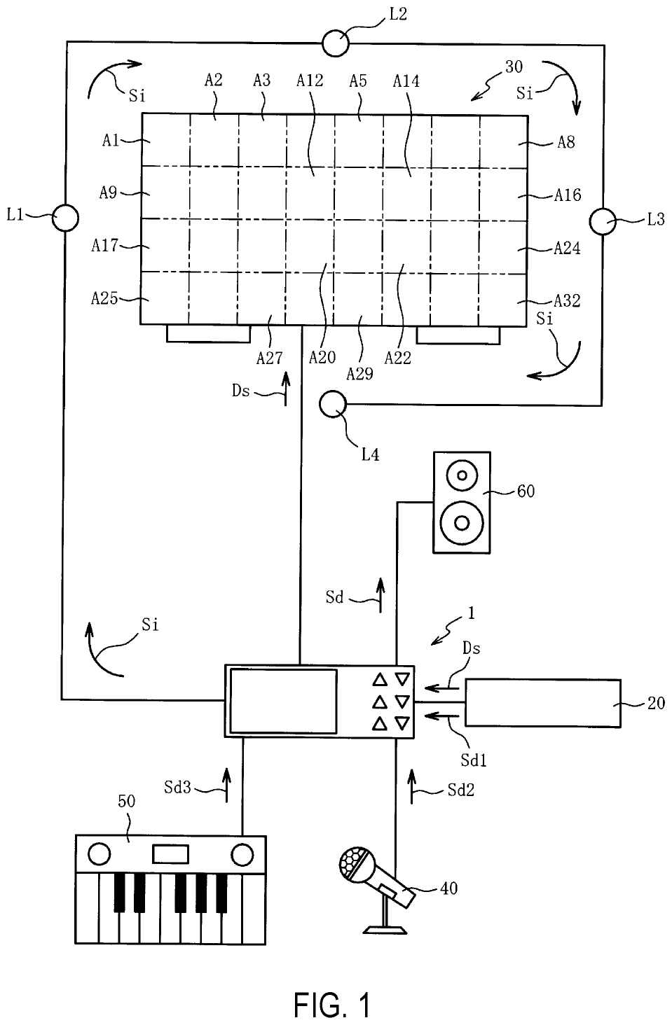

Hereinafter, an exemplary embodiment will be described with reference to the accompanying drawings. The summary of an illumination control device 1 according to this embodiment will be described below with reference to FIG. 1. FIG. 1 is a diagram illustrating an outline of the illumination control device 1. The illumination control device 1 is a device that controls illumination modes such as color tones, brightness, and luminance of illumination instruments L1 to L4 connected thereto. The illumination instruments L1 to L4, a video output device 20, an external display device 30, a microphone 40 to which sound Sd2 emitted from a user H and the like is input, an electronic musical instrument 50, and a speaker 60 are connected to the illumination control device 1.

The illumination instruments L1 to L4 are illumination devices that perform illumination and each have a light emitting diode (LED, which is not illustrated). The illumination control device 1 and the illumination instruments L1 to L4 are connected in a wired manner. Specifically, first, the illumination control device 1 and the illumination instrument L1 are connected in a wired manner, the illumination instrument L1 and the illumination instrument L2 are connected in a wired manner, the illumination instrument L2 and the illumination instrument L3 are connected in a wired manner, and the illumination instrument L3 and the illumination instrument L4 are connected in a wired manner. That is, the illumination control device 1 and the illumination instruments L1 to L4 are connected in a wired daisy chain manner.

The illumination control device 1 generates an illumination control signal Si including a set of illumination control values for controlling an illumination mode and transmits the generated illumination control signal S1 to the illumination instruments L1 to L4. Specifically, the illumination control signal Si generated by the illumination control device 1 is first transmitted to the illumination instrument L1, and then the illumination control signal Si is transmitted in the connection order of illumination instrument L2 illumination instrument L3 illumination instrument L4 from the illumination instrument L1. The illumination instruments L1 to L4 control a color tone, a color, brightness, luminance, and the like based on the set of illumination control values included in the received illumination control signal Si. The illumination control signal Si in this embodiment is considered to be a control signal based on the digital multiplex (DMX) 512 standard, but may be a control signal based on another standard.

Since a communication rate of the DMX 512 standard is 250 kbs and about 20 milliseconds is taken to transmit headers of few bytes and data of 512 bytes, it is not enough time for transmitting the headers of few bytes and data of 512 bytes in the communication rate of 250 kbs with “16.66667 ms” (a frame rate of 60 frames).

Accordingly, a period between each output process of a DMX 512 signal may be set to be in a range greater than “16.66667 ms” of “60 frames” and less than “33.33333 ms” of “30 frames.”

The period may be greater to reduce a load of a CPU. In this embodiment, since timer processing of the CPU including another processing is performed at intervals of “10 ms,” the period may be set to “30 ms.” For example, when the timer processing is performed at intervals of 8 ms, the output period of the DMX 512 signal may be set to “32 ms.”

The illumination instruments L1 to L4 acquire a set of illumination control values to be used by themselves out of the sets of illumination control values included in the illumination control signal S1 and control a color, brightness, luminance, and the like of themselves based on the acquired set of illumination control values. The set of illumination control values is generated based on video data Ds or the like output from the video output device 20.

The video output device 20 is a device that outputs video data Ds of a video captured by a video camera (not illustrated) or the like. The video data Ds and sound Sd1 corresponding to the video data Ds output from the video output device 20 are input to the illumination control device 1. The video data Ds in this embodiment is a video signal based on the high-definition multimedia interface (HDMI, registered trademark) standard, but may be a video signal based on another standard.

The external display device 30 is a device that displays a video corresponding to the video data Ds input from the video output device 20 via the illumination control device 1. The illumination instruments L1 to L4 are disposed at peripheral of the external display device 30. Specifically, in the external display device 30, the illumination instrument L1 is provided on the left side, the illumination instrument L2 is provided on the upper side, the illumination instrument L3 is provided on the right side, and the illumination instrument L4 is provided on the lower side. The electronic musical instrument 50 is a device that outputs musical sound Sd3 based on performance of a user H. In this embodiment, a synthesizer is exemplified as the electronic musical instrument 50, but the disclosure is not limited thereto and another electronic musical instrument such as an electronic piano, an electronic organ, or an electronic saxophone may be used. In addition, it is not limited to electronic musical instruments, and may be electric musical instruments. As an example of the electric musical instruments, a configuration in which the musical sound of an acoustic instrument is recorded with a microphone is also acceptable.

The illumination control device 1 generates sound Sd by synthesizing sound Sd1 input from the video output device 20, sound Sd2 input from the microphone 40, and musical sound Sd3 input from the electronic musical instrument 50. The generated sound Sd is output from the speaker 60 and changes illumination from the illumination instruments L1 to L4 according to the timing of the beat of the sound Sd. Change in illumination from the illumination instruments L1 to L4 according to the timing of the beat of the sound Sd will be described later. In this embodiment, sampling rates of the sound Sd1, the sound Sd2, the musical sound Sd3, and the sound Sd are 44100 Hz, but the sampling rates may be other frequencies.

In the illumination control device 1, the set of illumination control values for controlling the illumination instruments L1 to L4 is generated based on video data Ds of a video displayed on the external display device 30, that is, a video output from the video output device 20, and the sound Sd. The illumination control device 1 first divides video data Ds output from the video output device 20 into areas A1 to A32.

Specifically, 32 areas which are formed by dividing the video data Ds of the video output from the video output device 20 into four parts at equal intervals in the vertical direction and dividing the resultants into eight parts at equal intervals in the horizontal direction are the areas A1 to A32. As illustrated in FIG. 1, among the formed 32 areas, the areas in a first stage from the uppermost are areas A1 to A8 from the leftmost, the areas in a second stage are areas A9 to A16 from the leftmost, the areas in a third stage are areas A17 to A24 from the leftmost, and the areas in a fourth stage are areas A25 to A32 from the leftmost.

The set of illumination control values is generated based on the video data for each of the divisional areas A1 to A32 and the sound Sd. Specifically, screen sections are provided by grouping the areas A1 to A32. The screen sections which are used for control are allocated to the illumination instruments L1 to L4, and the sets of illumination control values corresponding to the video of the areas A1 to A32 belonging to the allocated screen sections are generated.

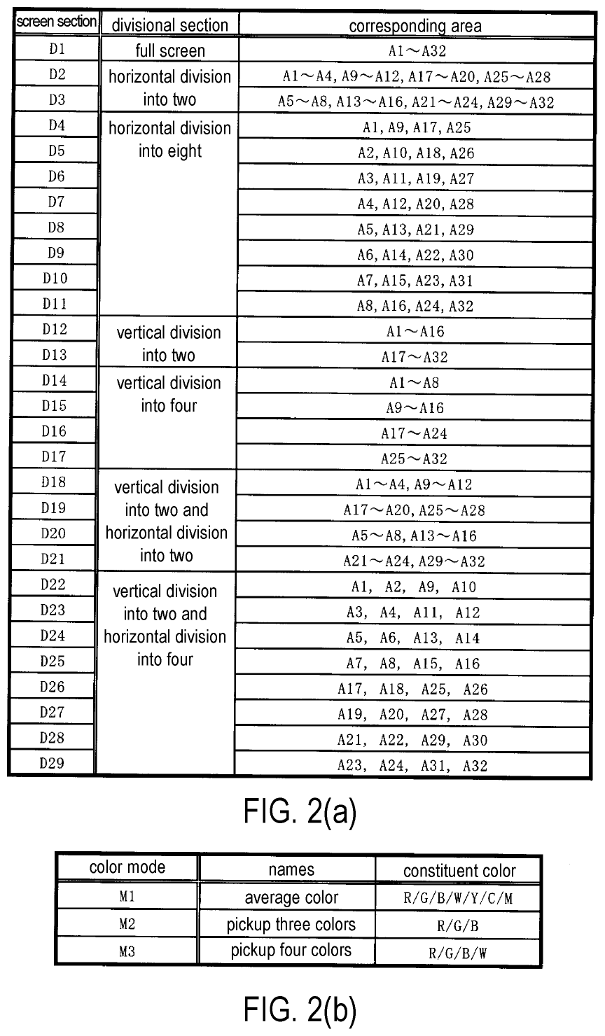

A set of illumination control values is generated from color information of the video of the areas A1 to A32 belonging to a target screen section, three color modes are set depending on usage of the color information, and which color mode is to be used is also allocated to each of the illumination instruments L1 to L4. The screen sections and the color modes will be described below with reference to FIG. 2(a) and FIG. 2(b).

FIG. 2(a) is a diagram illustrating the screen sections. As illustrated in FIG. 2(a), in this embodiment, 29 screen sections including screen sections D1 to D29 are provided based on division sections indicating combinations of the areas A1 to A32. First, a division section “full screen” is associated with all the video data Ds of a video and corresponds to the screen section D1. That is, the screen section D1 corresponds to the areas A1 to A32.

A division section “horizontal division into two” is associated with one of two parts into which the video data Ds of the video is horizontally divided and corresponds to the screen sections D2 and D3. Specifically, the screen section D2 corresponds to the areas A1 to A4, the areas A9 to A12, the areas A17 to A20, and the areas A25 to A28, and the screen section D3 corresponds to the areas A5 to A8, the areas A13 to A16, the areas A21 to A24, and the areas A29 to A32.

A division section “horizontal division into eight” is associated with one of eight parts into which the video data Ds of the video is horizontally divided and corresponds to the screen sections D4 to D11. For example, the screen section D4 corresponds to the areas A1, A9, A17, and A25, and the screen section D5 corresponds to the areas A2, A10, A18, and A26.

A division section “vertical division into two” is associated with one of two parts into which the video data Ds of the video is vertically divided and corresponds to the screen sections D12 and D13. Specifically, the screen section D12 corresponds to the areas A1 to A16, and the screen section D13 corresponds to the areas A17 to A32. A division section “vertical division into four” is associated with one of four parts into which the video data Ds of the video is vertically divided and corresponds to the screen sections D14 to D17.

A division section “vertical division into two and horizontal division into two” is associated with one part when the video data Ds of the video is vertically divided into two parts and is additionally horizontally divided into two parts and corresponds to the screen sections D18 to D21. A division section “vertical division into two and horizontal division into four” is associated with one part when the video data Ds of the video is vertically divided into two parts and is additionally horizontally divided into four parts and corresponds to the screen sections D22 to D29.

The screen sections D1 to D29 based on combinations of the areas A1 to A32 set in this way are allocated to the illumination instruments L1 to L4, and sets of illumination control values are generated based on color information of the video of the areas A1 to A32 belonging to the allocated screen sections D1 to D29. The color modes when the sets of illumination control values are generated will be described below.

FIG. 2(b) is a diagram illustrating the color modes. In this embodiment, three color modes based on combinations of color information of the video of the areas A1 to A32 belonging to the screen sections D1 to D29 are provided, and illumination of colors based on the color modes is output from the illumination instruments L1 to L4. Specifically, average color, pickup three colors, and pickup four colors are provided as the color modes.

The average color is a color mode based on an average of color information of the video of the areas A1 to A32 corresponding to the screen sections D1 to D29. Specifically, the average color is constituted by an average value of red components (hereinafter referred to as “R”), an average value of green components (hereinafter referred to as “G”), an average value of blue components (hereinafter referred to as “B”), an average value of white components (hereinafter referred to as “W”), an average value of yellow components (hereinafter referred to as “Y”), an average value of cyan components (hereinafter referred to as “C”), and an average value of magenta components (hereinafter referred to as “M”) of the areas A1 to A32 corresponding to the screen sections D1 to D29.

Calculation of the average color will be described below using the screen section D4 as an example. The screen section D4 includes the areas A1, A9, A17, and A25, and the average values of R, G, and B in the areas are assumed to be (R1, G1, B1), (R9, G9, B9), (R17, G17, B17), and (R25, G25, B25). The average values of R, G, and B in each area are obtained by dividing the total values of R, G, and B in the area by the number of pixels in the area.

For example, when the video data Ds of the video includes 1920 pixels×1080 pixels, the number of pixels in the area A1 which is one of 32 parts into which the video data Ds is divided is 64800 pixels from 1920×1080/32. When the total value of R in the area A1 is 15228000, the average value R1 of R in the area A1 is “235” by 15228000/64800.

R, G, and B of the average color in the screen section D4 are acquired by averaging the calculated average values of R, G, and B in the areas. Specifically, the average value of R in the screen section D4 is calculated by (R1+R9+R17+R25)/4 (that is, the number of areas in the screen section D4). Similarly, the average value of G in the screen section D4 is calculated by (G1+G9+G17+G25)/4, and the average value of B in the screen section D4 is calculated by (B1+B9+B17+B25)/4.

Regarding W, Y, C, and M, average values of W, Y, C, and M of the average color in the screen section D4 are obtained by calculating W, Y, C, and M of the areas in the screen section D4 based on the average values of R, G, and B in the areas, and additionally averaging W, Y, C, and M of the areas.

Specifically, W of each area is a minimum value of the average values of R, G, and B in the area. For example, when the minimum value of R1, G1, and B1 of the area A1 is G1, the value of G1 is set as W1 which is W of the area A1. Similarly, the minimum values of R, G, and B in the areas are set as W9, W17, and W25 of the areas A9, A17, and A25. By setting the minimum value of R, G, and B of each area as W of the area, the value of W in the area is 0 when one of R, G, and B (for example, one color of R, G, and B) is 0, and thus it is possible to avoid turning on an LED of W in the illumination instruments L1 to L4. The average value of W1, W9, W17, and W25 is the average value of W in the screen section D4.

Y of each area is a minimum value of the average values of R and G in the area. For example, when the minimum value of R9 and G9 of the area A9 is R9, the value of R9 is set as Y9 which is Y of the area A9. Similarly, the minimum values of R and G in the areas are set as Y1, Y17, and Y25 of the areas A1, A17, and A25. The average value of Y1, Y9, Y17, and Y25 is the average value of Y in the screen section D4.

C of each area is a minimum value of the average values of G and B in the area. For example, when the minimum value of G17 and B17 of the area A17 is B17, the value of B17 is set as C17 which is C of the area A17. Similarly, the minimum values of G and B in the areas are set as C1, C9, and C25 of the areas A1, A9, and A25. The average value of C1, C9, C17, and C25 is the average value of C in the screen section D4.

M of each area is a minimum value of the average values of R and B in the area. For example, when the minimum value of R25 and B25 of the area A25 is B25, the value of B25 is set as M25 which is M of the area A25. Similarly, the minimum values of R and B in the areas are set as M1, M9, and M17 of the areas A1, A9, and A17. The average value of M1, M9, M17, and M25 is the average value of M in the screen section D4.

In this way, by using the average values of R, G, B, W, Y, C, and M in the color information of a corresponding screen section as an average color for illumination of the illumination instruments L1 to L4, it is possible to make the illumination approach a color tone of a video which is displayed on the external display device 30. By providing W, Y, C, and M in addition to R, G, and B as the average color, it is possible to efficiently light LEDs of W, Y, C, and M when the illumination instruments L1 to L4 include the LEDs.

Pickup three colors will be described below. The pickup three colors is a color mode based on a maximum value of color information of a video in the areas A1 to A32 corresponding to the screen sections D1 to D29. Specifically, the pickup three colors is constituted by a value based on the maximum values of R, a value based on the maximum values of G, and a value based on the maximum values of B in the areas A1 to A32 corresponding to the screen sections D1 to D29.

The pickup three colors will be described below using the screen section D4 as an example. In the pickup three colors, R, G, and B of the maximum values (hereinafter referred to as “maximum R, G, and B” or the like) out of the average values of R, G, and B in the areas A1, A9, A17, and A25 constituting the screen section D4 are extracted. When an area in which R has a maximum value out of the average values of R, G, and B out of the areas constituting the screen section D4 is the areas A1 and A17, an area in which G has a maximum value out of the average values of R, G, and B is the area A9, and an area in which B has a maximum value out of the average values of R, G, and B is the area A25, R1 of the area A1 and R17 of the area A17 are extracted as the maximum R, G9 of the area A9 is extracted as the maximum G, and B25 of the area A25 is extracted as the maximum B.

R, G, and B of the pickup three colors in the screen section D4 are obtained by further averaging the extracted maximum R, G, and B. Specifically, the average value of the maximum R in the screen section D4 is calculated by (R1+R17)/4 (which is the number of areas in the screen section D4). Similarly, the average value of the maximum Gin the screen section D4 is calculated by G9/4, and the average value of the maximum B in the screen section D4 is calculated by B25/4.

In this way, by using a value based on the maximum values of R, G, and B in the corresponding screen section as the pickup three colors for illumination of the illumination instruments L1 to L4, the illumination can be made using a characteristic and dominant color of a video based on R, G, and B more included in the video displayed on the external display device 30. Accordingly, it is possible to make the illumination vary while matching the video displayed on the external display device 30.

Since the pickup three colors is a value based on the maximum values of R, G, and B of a screen section, it is possible to appropriately extract R, G, and B which are scattered even if R, G, and B in the video in the screen section are scattered in a white background and to use the extracted R, G, and B for illumination of the illumination instruments L1 to L4. Accordingly, since whitening of the illumination can be curbed, it is possible to make the illumination vary while matching the video displayed on the external display device 30.

Particularly, when LEDs of R, G, and B are included in the illumination instruments L1 to L4 and the LEDs of R, G, and B face independent directions, the LEDs of R, G, and B are independently turned on by using the average color of the color mode even if the corresponding screen section is a white video. Since the illumination output by independently turning on the LEDs of R, G, and B of the illumination instruments L1 to L4 does not match a white video, there is concern about a viewer feeling discomfort. Therefore, since turning-on with the same degree of intensity of the LEDs of three colors including R, G, and B can be curbed by using the pickup three colors as the color mode, it is possible to curb discomfort of a viewer.

Pickup four colors will be described below. The pickup four colors is also a color mode based on a maximum value of color information of a video in the areas A1 to A32 corresponding to the screen sections D1 to D29. Specifically, the pickup four colors is constituted by a value based on the maximum values of R, a value based on the maximum values of G, a value based on the maximum values of B, and a value based on the maximum values of W in the areas A1 to A32 corresponding to the screen sections D1 to D29.

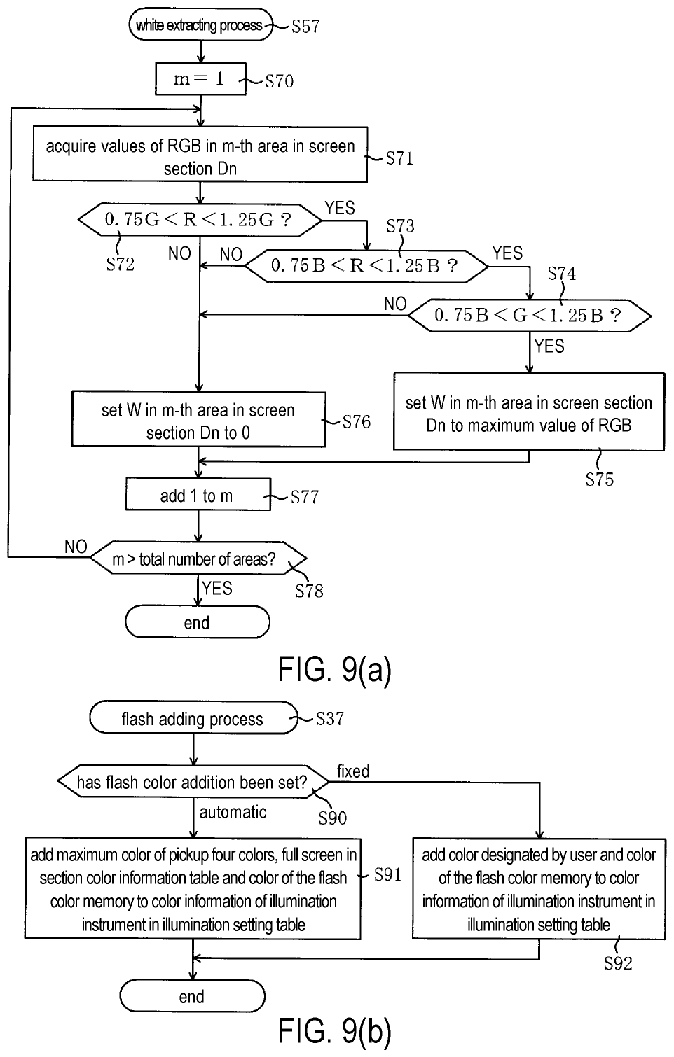

The pickup four colors will also be described below using the screen section D4 as an example. In the pickup four colors, first, W of each area is calculated. When the average values of R, G, and B in each area are similar, a maximum value of the average values of R, G, and B is W of the area. On the other hand, when the values of R, G, and B are not similar, “0” (no component) is set as W of the area. Whether the values of R, G, and B in each area are similar is determined by determining whether the values are within a range of ±25%, and details thereof will be described later with reference to FIG. 9(a). For example, when R1, G1, and B1 in the area A1 are within a range of ±25% and the maximum value of R1, G1, and B1 is B1, the value of B1 is set as W1 which is W of the area A1.

The maximum value of the average values of R, G, and B in each area is used as W of the area in the pickup four colors to extract a color with a characteristic and dominant component in the pickup four colors similarly to the pickup three colors.

R, G, B, and W of a maximum value (maximum R, G, B, and W) are extracted from the acquired W of each area and the average values of R, G, and B of the area, and the average value of the extracted maximum R, G, B, and W is calculated. Calculation of the maximum R, G, B, and W and the average value of the maximum R, G, B, and W is performed using the same method as in the pickup three colors and thus description thereof will be omitted.

In this way, by using a value based on the maximum values of R, G, B, and W of color information in the corresponding screen section as the pickup four colors for illumination of the illumination instruments L1 to L4, the illumination can be made using a characteristic and dominant color of a video included more in the video displayed on the external display device 30 similarly to the pickup three colors. Accordingly, it is possible to make the illumination vary while matching the video displayed on the external display device 30.

The pickup four colors additionally includes W. Particularly, when LEDs of R, G, B, and W are included in the illumination instruments L1 to L4 and the LEDs of R, G, B, and W face independent directions, only R, G, and B are targets by using the pickup three colors as the color mode, but the LEDs of R, G, and B are independently turned on even if the corresponding screen section is a white video. Since the illumination output by independently turning on the LEDs of R, G, and B of the illumination instruments L1 to L4 does not match a white video of the screen section, there is concern about a viewer feeling discomfort.

Therefore, since the LED of W out of the LEDs can be appropriately turned on by using the pickup four colors including W as the color mode, it is possible to cause the illumination of the illumination instruments L1 to L4 to match the white video of the screen section and to curb discomfort of a viewer.

In this way, the color mode for controlling illumination and the screen sections D1 to D29 of a target for which the color mode is generated are allocated to the illumination instruments L1 to L4. A set of illumination control values for controlling the illumination of the illumination instruments L1 to L4 is generated based on the allocated color mode and the allocated screen sections D1 to D29.

In this embodiment, the illumination of the illumination instruments L1 to L4 is changed based on a timing of a beat of sound Sd input to the illumination control device 1 in addition to control of the illumination of the illumination instruments L1 to L4 based on the color modes and the screen sections D1 to D29.

Specifically, whether a beat has been detected from the sound Sd input to the illumination control device 1, that is, the sound Sd obtained by combining sound Sd1 input from the video output device 20, sound Sd2 input from the microphone 40, and musical sound Sd3 input from the electronic musical instrument 50 is ascertained. A known method is used to detect a beat and thus detailed description thereof will be omitted.

When a beat bas been detected from the sound Sd, a color of a maximum value out of R, G, B, and Win the pickup four colors of the screen section D1 (that is, the full screen) is acquired, and the acquired value of a color is added to the set of illumination control values for controlling the illumination of the illumination instruments L1 to L4. Accordingly, in the illumination output from the illumination instruments L1 to L4, a characteristic and dominant color with a most intensive color tone out of R, G, B, and W of the pickup four colors is emphasized at the timing of the beat of the sound Sd. Accordingly, it is possible to further enhance a sense of immersion of a user H in a video displayed on the external display device 30 and sound output from the speaker 60.

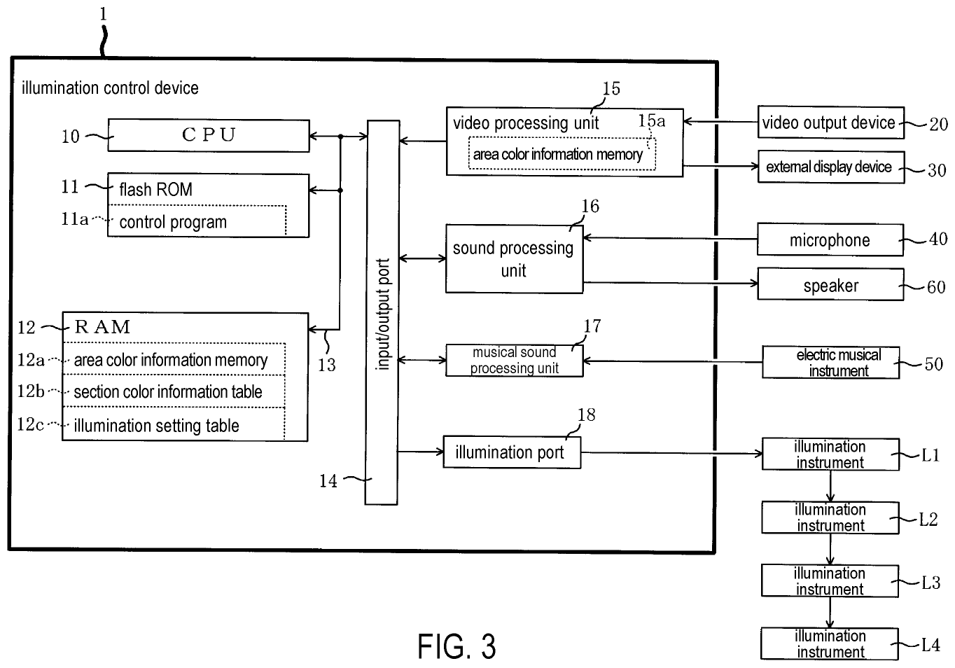

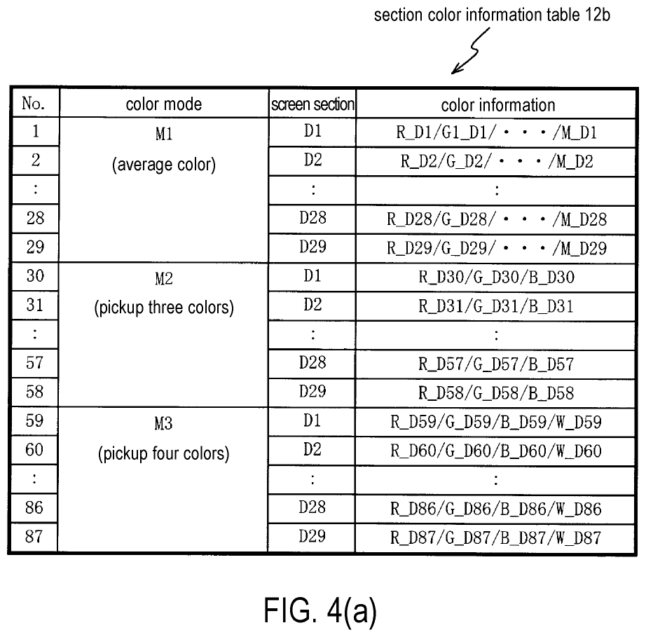

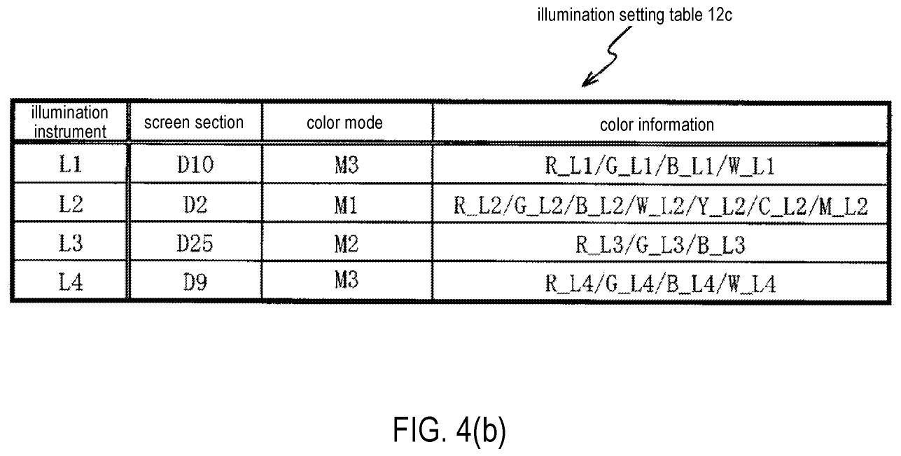

An electrical configuration of the illumination control device 1 will be described below with reference to FIGS. 3 and 4. FIG. 3 is a block diagram illustrating an electrical configuration of the illumination control device 1. The illumination control device 1 includes a central processing unit (CPU) 10 that is implemented as a signal processor, a flash ROM 11, and a RAM 12, which are connected to an input/output port 14 via a bus line 13. A video processing unit (video processor) 15, a sound processing unit (sound processor) 16, and a musical sound processing unit 17 to receives an input of musical sound Sd3 from the electronic musical instrument 50, and an illumination port 18 are connected to the input/output port 14. The function of the musical sound processing unit 17 may be provided to the sound processing unit 16 and the musical sound Sd3 from the electronic musical instrument 50 may be input to the sound processing unit 16.

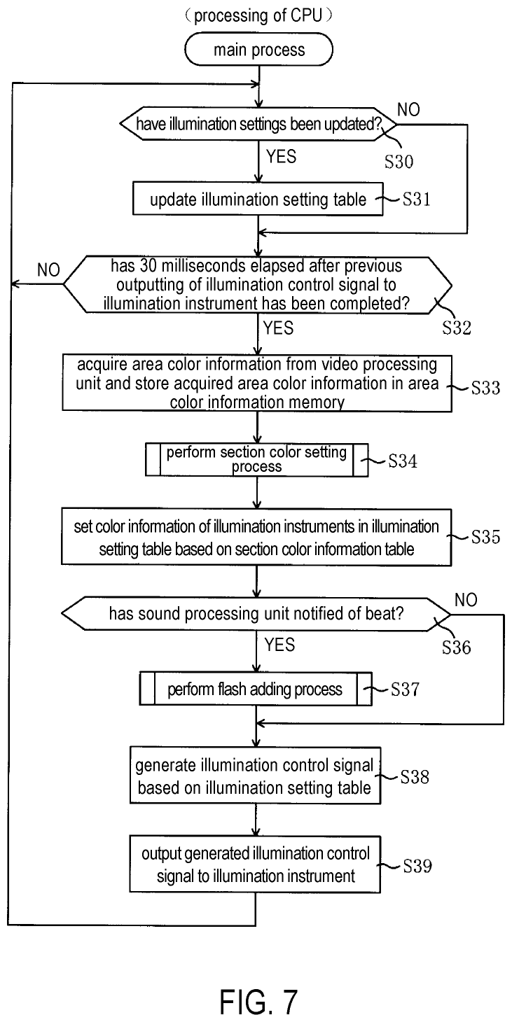

The CPU 10 is an arithmetic processing device that controls constituents connected thereto via the bus line 13. The flash ROM 11 is a rewritable nonvolatile storage device storing programs executed by the CPU 10 or fixed value data and includes a control program 11a. When the control program 11a is executed by the CPU 10, the main process illustrated in FIG. 7 is performed.

The RAM 12 is a memory for rewritably storing various types of work data, flags, and the like when the CPU 10 executes the control program 11a, and includes an area color information memory 12a in which color information of the areas A1 to A32, that is, R, G, and B, are stored, a section color information table 12b, and an illumination setting table 12c. The section color information table 12b and the illumination setting table 12c will be described below with reference to FIG. 4.

FIG. 4(a) is a diagram schematically illustrating the section color information table 12b. As illustrated in FIG. 4(a), in the section color information table 12b, the color mode and calculated color information of the color mode, that is, R, G, B, W, Y, C, and M when the color mode is the average color, R, G, and B when the color mode is the pickup three colors, and R, G, B, and W when the color mode is the pickup four colors, are stored for each screen section.

FIG. 4(b) is a diagram schematically illustrating the illumination setting table 12c. As illustrated in FIG. 4(b), in the illumination setting table 12c, a screen section, a color mode, and color information corresponding to the color mode used to control illumination are stored for each of the illumination instruments L1 to L4.

Description will be continued with reference back to FIG. 3. The video processing unit 15 is a processing device that receives an input of video data Ds and sound Sd1 from the video output device 20, acquires color information of the areas A1 to A32 from the input video data Ds, and outputs the video data Ds to the external display device 30. An area color information memory 15a in which the acquired color information of the areas A1 to A32 is stored is provided in the video processing unit 15. Whenever one frame of a video is input to the video processing unit 15 from the video output device 20, color information of the areas A1 to A32 is acquired and stored in the area color information memory 15a.

The sound processing unit 16 is a device that receives an input of sound Sd2 from the microphone 40, generates sound Sd by combining the sound Sd2, the sound Sd1 input from the video output device 20, and the musical sound Sd3 input from the electronic musical instrument 50, outputs the generated sound Sd to the speaker 60, and detects a beat from the sound Sd.

The illumination port 18 is a terminal that is connected to the illumination instruments L1 to L4 and outputs an illumination control signal S1 to the illumination instruments L1 to L4.

In this embodiment, acquisition of the video data Ds and acquisition of the color information of the areas A1 to A32 from the video data Ds which are performed by the video processing unit 15, detection of a beat from the sound Sd which is performed by the sound processing unit 16, and preparation of the illumination control signal Si based on the color information of the areas A1 to A32 and output of the illumination control signal Si from the illumination port 18 which are performed by the CPU 10 are asynchronously performed.

Specifically, acquisition of the video data Ds and acquisition of the color information of the areas A1 to A32 from the video data Ds which are performed by the video processing unit 15 are performed at a timing based on a frame rate (for example, 30 FPS) of the acquired video data Ds, and detection of a beat from the sound Sd which is performed by the sound processing unit 16 is performed at a timing based on a sampling rate (that is, 44100 Hz) of the sound Sd1, the sound Sd2, or the musical sound Sd3. On the other hand, preparation of the illumination control signal Si based on the color information of the areas A1 to A32 and output of the illumination control signal Si from the illumination port 18 which are performed by the CPU 10 are performed every 30 ms. This is because the illumination instruments L1 to L4 includes an illumination instrument that is turned off when the illumination control signal Si is not input at intervals of a predetermined period (for example, 30 ms). Here, the predetermined period refers to an repeated interval between the timing and the next timing for starting the processing instead of the time required from starting the process to the end.

In this way, by setting the period of preparation of the illumination control signal Si and output of the illumination control signal Si from the illumination port 18 to the period (that is, 30 ms) corresponding to the illumination instruments L1 to L4 to which the illumination control signal Si is output without depending on the frame rate of the video of the video data Ds or the sampling rate of the sound Sd1 or the like, it is possible to stably turn on the illumination instruments L1 to L4.

By setting the period of preparation of the illumination control signal S1 and output of the illumination control signal Si to a period longer than the frame rate and the sampling rate, it is possible to reduce a processing load of the CPU 10 generating the illumination control signal Si. Accordingly, since preparation of the illumination control signal Si or output of the illumination control signal Si from the illumination port 18 can be stabilized, it is also possible to stably turn on the illumination instruments L1 to L4.

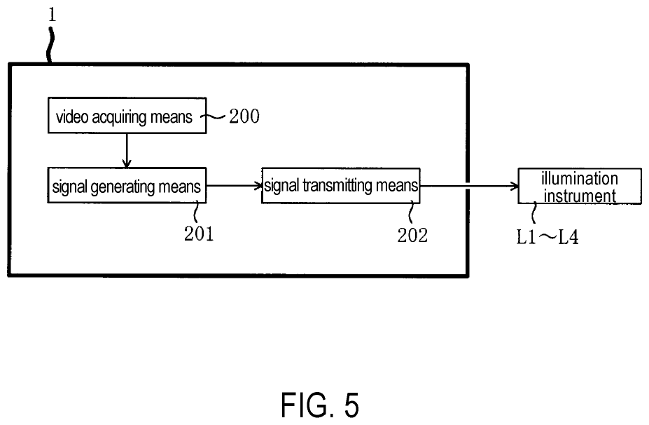

Functions of the illumination control device 1 will be described below with reference to FIG. 5. FIG. 5 is a functional block diagram of the illumination control device 1. As illustrated in FIG. 5, the illumination control device 1 includes a video acquiring means 200, a signal generating means 201, and a signal transmitting means 202.

The video acquiring means 200 is a means of acquiring video which is displayed on the external display device 30 and is implemented by the video processing unit 15. The signal generating means 201 is a means of generating an illumination control signal Si including a plurality of sets of illumination control values for controlling illumination and is implemented by the CPU 10. The signal transmitting means 202 is a means of transmitting the illumination control signal Si generated by the signal generating means 201 to one or more illumination instruments L1 to L4 at intervals of a predetermined period and is implemented by the CPU 10 and the illumination port 18.

The illumination control signal Si generated by the signal generating means 201 is transmitted to one or more illumination instruments L1 to L4 at intervals of a predetermined period by the signal transmitting means 202. That is, the illumination control signal Si can be transmitted to one or more illumination instruments L1 to L4 at intervals of a predetermined period regardless of the timing at which video is acquired. Accordingly, even when the illumination instruments L1 to L4 are turned off because the illumination control signal Si has not been received at intervals of the predetermined period, it is possible to stably turn on the illumination instruments L1 to L4.

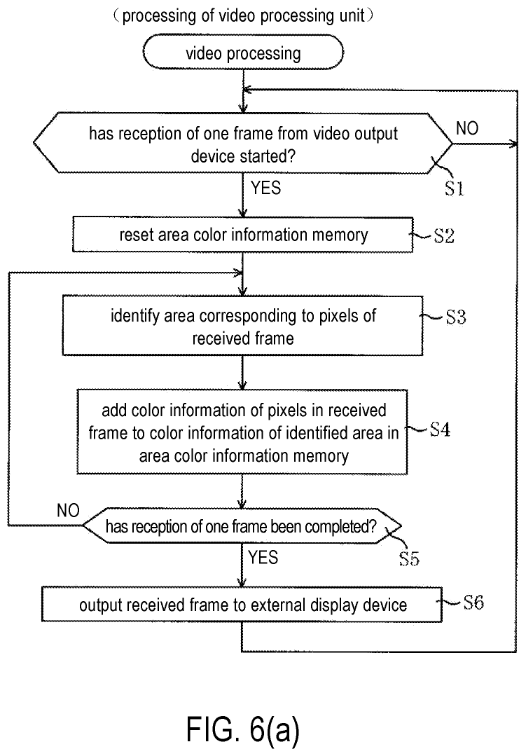

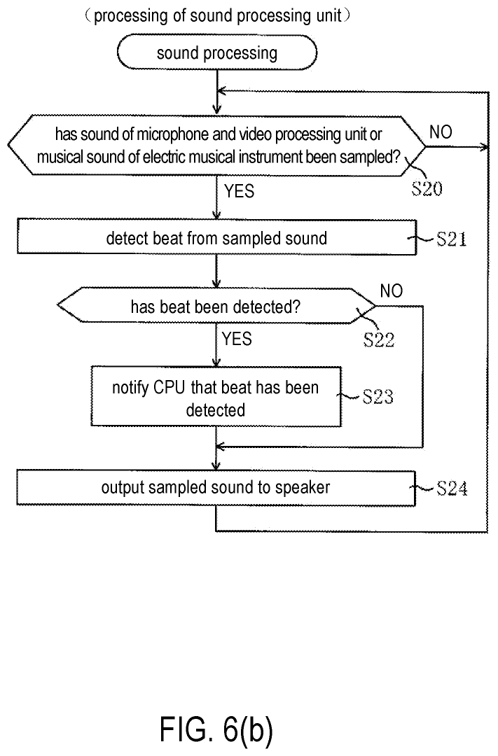

Processes which are performed by the CPU 10, the video processing unit 15, and the sound processing unit 16 will be described below with reference to FIGS. 6 to 9. The process performed by the video processing unit 15 will be first described below with reference to FIG. 6(a). FIG. 6(a) is a flowchart illustrating video processing which is performed by the video processing unit 15. The video processing is a process that is performed by the video processing unit 15 after the illumination control device 1 has been powered on.

In the video processing, first, it is ascertained whether reception of a video corresponding to one frame in the video output device 20 has started (S1). When it is determined in the process of S1 that reception of a video corresponding to one frame has started (S1: YES), the area color information memory 15a is reset by setting R, G, and B of the areas A1 to A32 in the area color information memory 15a to 0 (S2).

After the process of S2 has been performed, areas A1 to A32 corresponding to pixels of one frame which are received are identified (S3). Since pixels of the video corresponding to one frame are input from the video output device 20 sequentially from the upper-left corner of the video, the areas A1 to A32 corresponding to the positions of the input pixels are identified. After the process of S2 has been performed, the values of R, G, and B of the received pixels are added to the color information of the identified areas A1 to A32 in the area color information memory 15a.

After the process of S4 has been performed, it is ascertained whether reception of a video corresponding to one frame has been completed (S5). When it is determined in the process of S5 that reception of a video corresponding to one frame has not been completed (S5: NO), the processes of S3 and subsequent thereto are repeated. On the other hand, when it is determined in the process of S5 that reception of video corresponding to one frame has been completed (S5: YES), the received video corresponding to one frame is output to the external display device 30 (S6) and then the processes of S1 and subsequent thereto are repeated. The video received from the video output device 20 is not limited to outputting to the external display device 30 every frame, but may be output to the external display device 30 every pixel. The video from the video output device 20 is not limited to outputting to the external display device 30 via the video processing unit 15, but may be output to the external display device 30 while bypassing the video processing unit 15, for example, in parallel with outputting of the video from the video output device 20 to the video processing unit 15.

The color information of the areas A1 to A32 stored in the area color information memory 15a is referred to from the CPU 10 and is used for the CPU 10 to generate a set of illumination control values. In this case, when the area color information memory 15a is referred to from the CPU 10 while acquiring the color information corresponding to one frame in the processes of S1 to S5, the color information of the areas A1 to A32 acquired in an immediately previous frame which has been already processed is referred to. That is, the color information of the areas A1 to A32 acquired in the immediately previous frame is referred to while the processes of S1 to S5 are repeatedly being performed, and the color information of the areas A1 to A32 acquired through the processes of S1 to S5 is referred to after the processes of S1 to S5 have been completed, that is, after “S5: YES” has been achieved.

In the video processing unit 15, sound Sd1 input from the video output device 20 is output to the CPU 10 and the sound processing unit 16 in parallel with the processes of Si to S6.

The process performed by the sound processing unit 16 will be described below with reference to FIG. 6(b). FIG. 6(b) is a flowchart illustrating sound processing which is performed by the sound processing unit 16. The sound processing is a process that is performed by the sound processing unit 16 after the illumination control device 1 has been powered on.

In the sound processing, first, it is ascertained whether sound Sd2 from the microphone 40, sound Sd1 from the video processing unit 15, or musical sound Sd3 from the musical sound processing unit 17 has been sampled (S20). When it is ascertained in the process of S20 that the sound Sd1, the sound Sd2, or the musical sound Sd3 has been sampled, sound Sd is generated by combining the sampled sound Sd1, sound Sd2, or musical sound Sd3, and detects a beat of the sound Sd (S21).

After the process of S21 has been performed, it is ascertained whether a beat has been detected in the process of S21 (S22). When it is ascertained in the process of S22 that a beat has been detected (S22: YES), the CPU 10 is notified that a beat has been detected (S23). When it is ascertained in the process of S22 that a beat has not been detected (S22: NO), the process of S23 is skipped.

After the processes of S22 and S23 have been performed, the sound Sd is output to the speaker 60 (S24). The sound Sd1, the sound Sd2, or the musical sound Sd3 is not limited to outputting to the speaker 60 via the sound processing unit 16, but may be output to the speaker 60 by bypassing the sound processing unit 16, for example, in parallel with outputting of the sound Sd1, the sound Sd2, or the musical sound Sd3 to the sound processing unit 16. When it is ascertained in the process of S20 that the sound Sd1 or the like has not been sampled (S20: NO), the processes of S20 or subsequent thereto are repeated after the process of S24 has been performed.

The processes which are performed by the CPU 10 will be described below with reference to FIGS. 7 to 9. FIG. 7 is a flowchart illustrating a main process which is performed by the CPU 10. The main process is a process that is performed by the CPU 10 after the illumination control device 1 has been powered on.

In the main process, first, it is ascertained whether illumination settings, that is, the color modes and the screen sections allocated to the illumination instruments L1 to L4, have been updated by a user H using an operation button which is not illustrated (S30). When it is ascertained in the process of S30 that the illumination settings have been updated (S30: YES), the illumination setting table 12c is updated based on the updated illumination settings (S31). When it is ascertained in the process of S30 that the illumination settings have not been updated (S30: NO), the process of S31 is skipped.

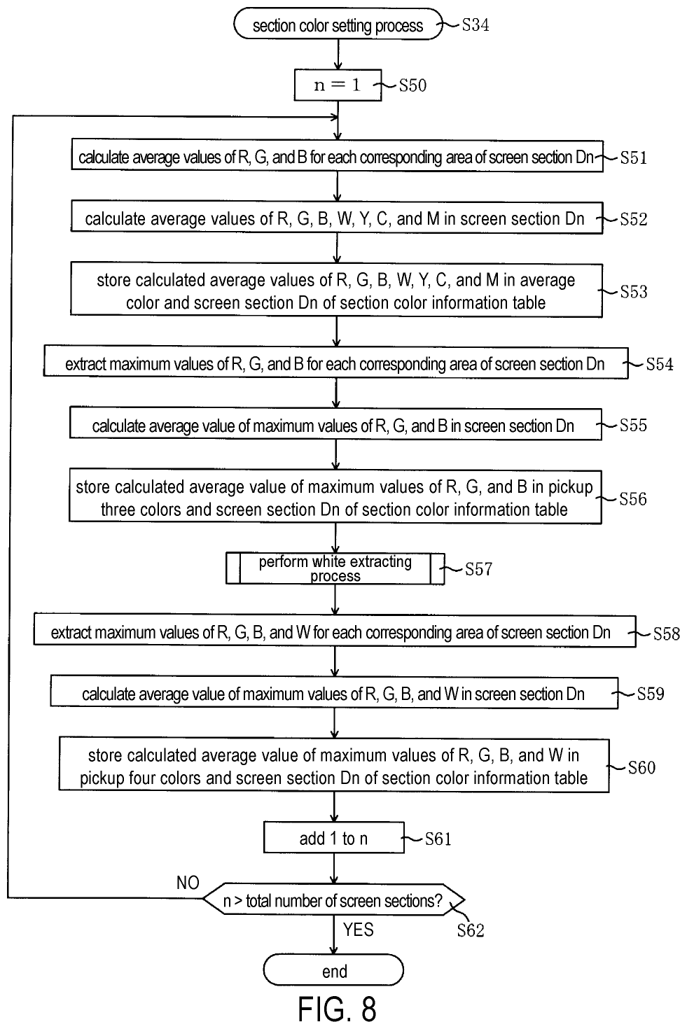

After the processes of S30 and S31 have been performed, it is ascertained whether 30 ms has elapsed after an illumination control signal Si has been previously output from the illumination port 18 to the illumination instruments L1 to L4 (S32). When it is ascertained in the process of S32 that 30 ms has elapsed after the illumination control signal Si has been previously output (S32: YES), color information of the areas A1 to A32 is acquired with reference to the area color information memory 15a of the video processing unit 15 and is stored in the area color information memory 12a (S33). After the process of S33 has been performed, a section color setting process (S34) is performed. The section color setting process will be described below with reference to FIG. 8.

FIG. 8 is a flowchart illustrating the section color setting process. In the section color setting process, first, a counter variable n indicating the screen sections D1 to D29 is set to 1 (S50). Hereinafter, “screen section Dn” indicates the screen section D1 when n is 1 and indicates the screen section D10 when n is 10.

After the process of S50 has been performed, average values of R, G, and B in the areas A1 to A32 (that is, R1 to R32, G1 to G32, and B1 to B32 which are described above) belonging to the screen section Dn are calculated based on the color information in the area color information memory 15a (S51). After the process of S51 has been performed, average values of R, G, B, W, Y, C, and M, that is, the average colors, in the screen section Dn, are calculated (S52).

Regarding the average values of W, Y, C, and M for the areas A1 to A32, that is, W1 to W32, Y1 to Y32, C1 to C32, and M1 to M32, are calculated based on the average values of R, G, and B of the areas A1 to A32 belonging to the screen section Dn as described above, and average values thereof are the average colors of W, Y, C, and M. After the process of S52 has been performed, the calculated average values of R, G, B, W, Y, C, and M are stored in areas of the screen section Dn and the color mode “average color” in the section color information table 12b (S53).

After the process of S53 has been performed, maximum values of R, G, and B for the areas A1 to A32 belonging to the screen section Dn are extracted based on the color information in the area color information memory 15a (S54). After the process of S54 has been performed, an average value of the maximum values of R, G, and B in the screen section Dn is calculated (S55). After the process of S55 has been performed, the calculated average value of the maximum values of R, G, and B is stored in areas of the screen section Dn and the color mode “pickup three colors” in the section color information table 12b (S56).

After the process of S56 has been performed, a white extracting process (S56) is performed. The white extracting process will be described below with reference to FIG. 9(a).

FIG. 9(a) is a flowchart illustrating the white extracting process. In the white extracting process, each corresponding area of the screen section Dn is processed. In the white extracting process, a counter variable m is set to 1 (S70). In the screen section Dn, the areas A1 to A32 are set in the ascending order, and, for example, the areas are set in the order of the areas A1, A2, A9, and A10 in the screen section D22 illustrated in FIG. 2(a). Accordingly, in the following description, the “m-th area” indicates the area A1 when m is 1 in the screen section D22 and indicates the area A9 when m is 3 in the screen section D22.

After the process of S70 has been performed, R, G, and B of the m-th area in the screen section Dn are acquired based on the color information in the area color information memory 15a (S71). After the process of S71 has been performed, it is ascertained whether the acquired R is greater than a value obtained by multiplying the acquired G by 0.75 and less than a value obtained by multiplying the acquired G by 1.25 (S72). When it is ascertained in the process of S72 that the acquired R is greater than a value obtained by multiplying the acquired G by 0.75 and less a value obtained by multiplying the acquired G by 1.25 (S72: YES), it is ascertained whether the acquired R is greater than a value obtained by multiplying the acquired B by 0.75 and less than a value obtained by multiplying the acquired B by 1.25 (S73).

When it is ascertained in the process of S73 that the acquired R is greater than the value obtained by multiplying the acquired B by 0.75 and less than the value obtained by multiplying the acquired B by 1.25 (S73: YES), it is ascertained whether the acquired G is greater than the value obtained by multiplying the acquired B by 0.75 and less than the value obtained by multiplying the acquired B by 1.25 (S74).

When it is ascertained in the process of S74 that the acquired G is greater than the value obtained by multiplying the acquired B by 0.75 and less than the value obtained by multiplying the acquired B by 1.25 (S74: YES), the acquired R, G, and B are within a range of ±25% and can be considered to be “white,” and thus a maximum value of the acquired R, G, and B is set as W of the m-th area in the screen section Dn (S75).

When it is ascertained in the process of S72 that the acquired R is equal to or less than the value obtained by multiplying the acquired G by 0.75 or equal to or greater than the value obtained by multiplying the acquired G by 1.25 (S72: NO), when it is ascertained in the process of S73 that the acquired R is equal to or less than the value obtained by multiplying the acquired B by 0.75 or equal to or greater than the value obtained by multiplying the acquired B by 1.25 (S73: NO), or when it is ascertained in the process of S74 that the acquired G is equal to or less than the value obtained by multiplying the acquired B by 0.75 or equal to or greater than the value obtained by multiplying the acquired B by 1.25 (S74: NO), 0 is set as W of the m-th area of the screen section Dn (S76).

After the processes of S75 and S76 have been performed, 1 is added to the counter variable m (S77) and it is ascertained whether the counter variable m is greater than the number of areas belonging to the screen section Dn (S78). When it is ascertained in the process of S78 that the counter variable m is equal to or less than the number of areas belonging to the screen section Dn (S78: NO), the processes of S71 and subsequent thereto are repeated. On the other hand, when it is ascertained in the process of S78 that the counter variable m is greater than the number of areas belonging to the screen section Dn (S78: YES), the white extracting process ends. In the white extracting process, the ranges of R, G, and B in which the color can be considered to be “white” is not limited to the range of ±25%, but may be equal to or greater than the range of ±25% or may be equal to or less than the range of ±25%.

Description will be continued with reference back to FIG. 8. After the white extracting process of S57 has been performed, the maximum values of R, G, B, and W for the areas A1 to A32 belonging to the screen section Dn are extracted based on the color information in the area color information memory 15a and W set in the white extracting process (S58). After the process of S58 has been performed, an average value of the maximum values of R, G, B, and W in the screen section Dn is calculated (S59). After the process of S59 has been performed, the calculated average value of the maximum values of R, G, B, and W is stored in areas of the screen section Dn and the color mode “pickup four colors” in the section color information table 12b (S60).

After the process of S60 has been performed, 1 is added to a counter variable n (S61) and it is ascertained whether the counter variable n is greater than the total number of screen sections (that is, “29) (S62). When it is ascertained in the process of S62 that the counter variable n is equal to or less than the total number of screen sections (S62: NO), the processes of S51 and subsequent thereto are repeated. On the other hand, when it is ascertained in the process of S62 that the counter variable n is greater than the total number of screen sections (S62: YES), the section color setting process ends.

Description will be continued with reference back to FIG. 7. After the section color setting process of S34 has been performed, color information of the illumination instruments L1 to L4 in the illumination setting table 12c is set based on the section color information table 12b (S35). Specifically, color information corresponding to the screen section and the color mode set for the illumination instruments L1 to L4 in the illumination setting table 12c is acquired from the section color information table 12b and is set in the color information in the illumination setting table 12c.

After the process of S35 has been performed, it is ascertained whether the sound processing unit 16 has notified that a beat has been detected (S36). When it is ascertained in the process of S36 that the sound processing unit 16 has notified that a beat has been detected (S36: YES), a flash adding process (S37) is performed. The flash adding process will be described below with reference to FIG. 9(b).

FIG. 9(b) is a flowchart illustrating the flash adding process. In the flash adding process, first, flash color addition settings set by a user H using an operation button which is not illustrated is ascertained (S90). Two settings including “fixed” in which a color set by the user H using the operation button is added to the color information in the illumination setting table 12c and “automatic” in which the maximum value of R, G, B, and Win the pickup four colors in the screen section D1 (that is, full screen) is added to the color information in the illumination setting table 12c are provided as the flash color addition settings.

When it is ascertained in the process of S90 that the flash color addition settings are automatic (S90: “automatic”), the maximum value of a maximum color in the color information of the pickup four colors and the screen section D1 (full screen) in the section color information table 12b is added to the color information in the illumination setting table 12c (S91). On the other hand, when it is ascertained in the process of S90 that the flash color addition settings are fixed (S90: “fixed”), a value of the color set by the user H in the color information of the pickup four colors and the screen section D1 (full screen) in the section color information table 12b is added to the corresponding color information in the illumination setting table 12c (S92). After the processes of S91 and S92 have been performed, the flash adding process ends.

Description will be continued with reference back to FIG. 7. When it is ascertained in the process of S36 that the sound processing unit 16 has not notified that a beat has been detected (S36: NO), the flash adding process is skipped in the process of S37.

After the processes of S36 and S37 have been performed, a set of illumination control values for controlling the illumination instruments L1 to L4 is generated based on the color information in the illumination setting table 12c, and an illumination control signal Si of the DMX 512 standard is generated from the set of illumination control values (S38). The illumination control signal Si generated in the process of S38 is data of 512 bytes based on the DMX 512 standard.

After the process of S38 has been performed, the generated illumination control signal Si is output to the illumination instruments L1 to L4 via the illumination port 18 (S39). When it is ascertained in the process of S32 that 30 ms has not elapsed from the illumination control signal Si has been previously output (S32: NO), or after the process of S39 has been performed, the processes of S30 and subsequent thereto are repeated.

While description has been made above in conjunction with the embodiment, it can be easily understood that various improvements and modifications are possible.

In the embodiment, the illumination control device 1 controls the illumination from the illumination instruments L1 to L4 which are disposed at peripheral of the external display device 30, but the disclosure is not limited thereto. For example, the illumination instruments L1 to L4 may be disposed at positions non-related to the external display device 30 on the indoor ceilings, walls, floors, and the like and the illumination from the illumination instruments L1 to L4 may be controlled by the illumination control device 1 regardless of a video which is displayed on the external display device 30.

In the embodiment, a video based on the video data Ds is divided into 32 areas such as the areas A1 to A32, but the number of divisional areas may be equal to or less than 32 or equal to or greater than 32. The screen sections D1 to D29 illustrated in FIG. 2(a) are provided as screen sections, but the disclosure is not limited thereto and screen sections based on combinations of the areas A1 to A32 other than the screen sections D1 to D29 may be provided. The shapes of the areas A1 to A32 are rectangular, but the disclosure is not limited thereto. For example, the shapes may be a polygon other than a rectangle such as a triangle or a pentagon or may be another shape such as a circle, an ellipse, or a star shape.

In the embodiment, when a beat of the sound Sd is detected, a maximum color in the color information of the screen section D1 of the pickup four colors or a color set by a user H in the color information of the pickup four colors and the screen section D1 (full screen) is added to the color information in the illumination setting table 12c, but the disclosure is not limited thereto. For example, when a sound volume or a sound pitch of the sound Sd is greater than a predetermined value or when sound in a predetermined frequency band is detected from the sound Sd, the maximum color in the color information of the pickup four colors and the screen section D1 or the like may be added to the color information in the illumination setting table 12c. In this case, the CPU 10 may be notified that the sound volume or the sound pitch is higher than the predetermined value or that the sound in the predetermined frequency band has been detected from the sound Sd instead of causing the sound processing unit 16 to notify the CPU 10 that a beat has been detected.

A maximum color in the color information of the screen section D1 in the pickup three colors may be used instead of the maximum color in the color information of the screen section D1 in the pickup four colors. In this case, the maximum color in the color information of the screen section D1 in the pickup four colors may be used when the illumination instruments L1 to L4 include an LED of W illumination, and the maximum color in the color information of the screen section D1 in the pickup three colors may be used when the illumination instruments L1 to L4 does not include an LED of W illumination. The disclosure is not limited to using of the maximum color in the color information of the screen section D1 in the pickup four colors, and color information of the pickup four colors of another screen section such as a maximum color in the color information of the screen section D2 in the pickup four colors may be used.

When the flash color addition settings are “fixed,” a color set by a user H in the color information of the pickup four colors and the screen section D1 (full screen) is added to the color information in the illumination setting table 12c, but the disclosure is not limited thereto. For example, a color, which is set by a user H, non-related to the color information of the pickup four colors and the screen section D1 may be added to the color information in the illumination setting table 12c. A plurality of colors to be added may be set in advance by a user H, and a color randomly selected from the set colors may be added to the color information in the illumination setting table 12c.

Addition to the color information in the illumination setting table 12c when a beat has been detected from the sound Sd may be independently performed on the illumination instruments L1 to L4. For example, a maximum color in the color information of the screen section and the color mode allocated to each of the illumination instruments L1 to L4 may be added to the corresponding color information in the illumination setting table 12c. Accordingly, change of the illumination instruments L1 to L4 when a beat has been detected from the sound Sd may be made to be different depending on the illumination instruments L1 to L4.

Instead of detecting a beat from the sound Sd in which sound Sd1, sound Sd2, and musical sound Sd3 are combined, a beat may be detected, for example, from only the sound Sd1, and a beat may be similarly detected from only the sound Sd2 or from only the musical sound Sd3.

In the embodiment, the illumination control signal Si of the DMX 512 standard generated every 30 ms is set to 512 bytes, but the disclosure is not limited thereto. The period in which the illumination control signal Si is generated may be equal to or less than 30 ms or equal to or greater than 30 ms. For example, when a frame rate of video data Ds is 60 FPS which is shorter than 30 FPS, the illumination control signal Si of the DMX 512 standard which is generated may be set to be 256 bytes, and 256 bytes may be transmitted to the illumination instruments L1 to L4 every 15 ms. The period in which the illumination control signal Si is generated or a data volume of the illumination control signal Si may be able to be set by a user H.

In the embodiment, the pickup three colors based on the maximum value of R, G, and B and the pickup four colors based on the maximum value of R, G, B, and W are provided as the color modes, but the disclosure is not limited thereto. For example, a color mode (pickup seven colors) based on a maximum value of R, G, B, W, Y, C, and M may be provided. An average value of seven colors (R, G, B, W, Y, C, and M) is used as the average color of the color mode, but the disclosure is not limited thereto and an average value of three colors (R, G, and B) may be used or an average value of four colors (R, G, B, and W) may be used.

In the embodiment, the video output device 20 is used as a device that outputs video data Ds of a video captured by a video camera or the like, but the disclosure is not limited thereto. For example, the video output device 20 may be constituted by a DVD player and output video data Ds of a video recorded on a DVD or the like, or the video output device 20 may be constituted by a TV tuner and output video data Ds of received TV broadcast. The video output device 20 may be configured to be connectable to the Internet and output video data Ds such as a live video acquired via the Internet. The video output device 20 may be constituted by a Karaoke machine.

Instead of the video output device 20, a potable recording medium such as a USB (registered trademark) memory may be connected to the illumination control device 1 and video data Ds acquired by reproducing a video file stored in the recording medium may be used.

Speech of a user H input from the microphone 40 is used as the sound Sd2, but the disclosure is not limited thereto. For example, a shout for joy or clapping to a beat by a viewer input from the microphone 40 may be used as the sound Sd2, or performance sound of a piano or a guitar by a player input from the microphone 40 may be used.

In the embodiment, the period in which an illumination control signal Si is generated and the illumination control signal Si is output from the illumination port 18 is set to a period based on the illumination instruments L1 to L4 from which the illumination control signal Si is output regardless of the frame rate of a video of video data Ds or a sampling rate of the sound Sd1 or the like. However, the disclosure is not limited thereto, and as long as the illumination instruments L1 to L4 can be stably turned on, the period in which an illumination control signal Si is generated and the illumination control signal Si is output may be set to the same period as the frame rate of a video of the video data Ds or may be set to a period shorter than the frame rate. Similarly, the period in which an illumination control signal Si is generated and the illumination control signal Si is output may be set to a period based on the sampling rate of the sound Sd1 or the like.

Preparation of the illumination control signal S1 and outputting of the illumination control signal Si are not limited to being synchronously performed in the same period, but they may be performed asynchronously. For example, the period in which the illumination control signal Si is generated may be set to be shorter than the period in which the illumination control signal Si is output or longer than that period.

In the embodiment, acquisition of color information of one frame input from the video output device 20 is performed by the video processing unit 15, but the disclosure is not limited thereto. For example, acquisition of color information of one frame may be performed by the CPU 10. In this case, the CPU 10 can perform, for example, acquisition of color information of one frame, preparation of the illumination control signal Si, and outputting of the illumination control signal Si every 30 ms in parallel in order to maintain preparation of the illumination control signal Si and outputting of the illumination control signal Si every 30 ms. Similarly, detection of a beat from the sound Sd is performed by the sound processing unit 16, but the disclosure is not limited thereto and detection of a beat may be performed by the CPU 10.

In the embodiment, average values of R, G, and B of the areas A1 to A32 corresponding to the screen section Dn are calculated in the process of S51 of FIG. 8, maximum values of R, G, and B of the areas A1 to A32 corresponding to the screen section Dn are extracted in the process of S54, W of the areas A1 to A32 corresponding to the screen section Dn is set in the white extracting process of S57, and a maximum value of R, G, B, and W of the areas A1 to A32 corresponding to the screen section Dn is extracted in the process of S58.

However, the disclosure is not limited thereto, and calculation of the average values of R, G, and B of the areas A1 to A32, extraction of the maximum values of R, G, and B of the areas A1 to A32, setting of W of the areas A1 to A32, and extraction of the maximum value of R, G, B, and W of the areas A1 to A32 may be performed in advance (for example, before the process of S50 is performed). In this case, the processes of S51, S54, S57, and S58 may be omitted, the average values of R, G, and B of the areas A1 to A32 corresponding to the screen section Dn out of the average values of R, G, and B of the areas A1 to A32 calculated in advance may be used in the processes of S52 and S53, the maximum values of R, G, and B of the areas A1 to A32 corresponding to the screen section Dn out of the maximum values of R, G, and B of the areas A1 to A32 extracted in advance may be used in the process of S55, and the maximum value of R, G, B, and W of the areas A1 to A32 corresponding to the screen section Dn out of the maximum values of R, G, B, and W of the areas A1 to A32 extracted in advance may be used in the process of S59.

In the embodiment, the illumination control device 1 generates the illumination control signal Si based on the video data Ds and the sound Sd, but the disclosure is not limited thereto. For example, a musical instrument digital interface (MIDI) may be acquired from an electronic device which is not limited to the electronic musical instrument 50, MIDI data thereof may be converted to an illumination control signal Si, and the illumination control signal Si may be used to control the illumination instruments L1 to L4.

In the embodiment, the illumination instruments L1 to L4 are connected to the illumination control device 1 via the illumination port 18 in a wired manner, and an illumination control signal Si is transmitted thereto. However, the disclosure is not limited thereto, and, for example, the illumination control device 1 and the illumination instruments L1 to L4 may be connected using a wired LAN and an illumination control signal Si may be transmitted via the wired LAN. In this case, Art-Net is exemplified as a communication protocol for transmitting the illumination control signal Si via the wired LAN, but another communication protocol may be used. The illumination control device 1 and the illumination instruments L1 to L4 may be connected by wireless communication (for example, Bluetooth (registered trademark)) and the illumination control signal Si may be transmitted by the wireless communication.

In the aforementioned embodiment, the illumination control device 1 into which the control program 11a is incorporated has been described, but the disclosure is not limited thereto and the control program 11a may be executed by an information processing device (a computer) such as a personal computer.

In the illumination control device and the illumination control method according to the embodiment, the video acquiring means 200 is implemented in the process of S1 by the video processing unit (a video processor). The signal generating means 201 is implemented in the process of S38 by the CPU 10 which is realized as a signal processor. The signal transmitting means 202 is implemented in the process of S39 by the CPU 10 and the illumination port 18. The sound acquiring means is implemented in the process of S20 by the sound processing unit (a sound processor) 16. The sound feature timing acquiring means is implemented in the process of S22 by the sound processing unit 16.

The video acquiring means, the signal generating means, the signal transmitting means, the sound acquiring means, and the sound feature timing acquiring means are implemented by causing the CPU 10 illustrated in FIG. 3 to execute the control program 11a. At least some thereof may be implemented by hardware such as an electronic circuit (for example, an FPGA or a dedicated LSI).

In the aforementioned embodiment, an illumination control device is provided. The illumination control device includes: a video processor configured to acquire a video; and a signal processor configured to generate an illumination control signal including a plurality of sets of illumination control values for controlling illumination based on the video acquired by the video processor and to transmit the generated illumination control signal to one or more illumination instruments at intervals of a predetermined period.

The signal processor is implemented by the CPU 10. For example, the signal processor performs the routine illustrated in FIG. 7 using the CPU 10. The sound processor is implemented by at least one of the sound processing unit 16 and the musical sound processing unit 17 illustrated in FIG. 3. All or some processes of the video processing unit (a video processor) 15, the sound processing unit (a sound processor) 16, and the musical sound processing unit 17 may be performed by the CPU 10. Some processes of the CPU 10 may be performed by the video processing unit 15, the sound processing unit 16, and the musical sound processing unit 17. A part of the CPU 10 and all or a part of the video processing unit 15, the sound processing unit 16, and the musical sound processing unit 17 may be constituted by an FPGA, a dedicated LSI, or the like.

The numerical values mentioned in the aforementioned embodiment are examples and other numerical values can also be employed.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An illumination control device comprising:
a video processor configured to acquire video; and
a signal processor configured to generate an illumination control signal comprising a plurality of sets of illumination control values for controlling illumination based on the video acquired by the video processor and to transmit the generated illumination control signal to one or more illumination instruments at intervals of a predetermined period.

2. The illumination control device according to claim 1, wherein the signal processor transmits the generated illumination control signal to one or more illumination instruments at least at intervals of a predetermined period which does not depend on a frame rate of the video acquired by the video processor.

3. The illumination control device according to claim 1, wherein the predetermined period is set based on the illumination instrument to which the illumination control signal is transmitted.

4. The illumination control device according to claim 2, wherein the predetermined period is set to be in a range greater than 16.66667 ms and less than 33.33333 ms.

5. The illumination control device according to claim 1, further comprising a sound processor configured to acquire sound and to acquire a timing at which a sound feature which is a predetermined feature of the sound is output from the acquired sound,
wherein the signal processor changes illumination control values based on the video acquired by the video processor at the timing acquired by the sound processor and generates the illumination control signal based on the illumination control values.

6. The illumination control device according to claim 2, wherein the predetermined period is set to be multiple times of a period of a timer of the signal processor for process other than generating and transmitting the illumination control signal.

7. The illumination control device according to claim 3, wherein the predetermined period is set to be multiple times of a period of a timer of the signal processor for process other than generating and transmitting the illumination control signal.

8. The illumination control device according to claim 5, wherein the video processor acquires a feature color which is a characteristic color of the video from the acquired video, and
wherein the signal processor generates illumination control values based on the feature color acquired at the timing acquired by the sound processor and generates the illumination control signal based on the illumination control values.

9. The illumination control device according to claim 6, wherein the predetermined period is set to be as greater as possible.

10. The illumination control device according to claim 7, wherein the predetermined period is set to be as greater as possible.

11. The illumination control device according to claim 5, wherein the signal processor transmits the generated illumination control signal to one or more illumination instruments at intervals of a predetermined period which does not depend on at least a sampling rate of the sound acquired by the sound processor.

12. The illumination control device according to claim 5, wherein the sound feature is a beat of the sound acquired by the sound processor.

13. The illumination control device according to claim 1, wherein the video is a video signal based on an HDMI (registered trademark) standard and the illumination control signal is a control signal based on a DMX 512 standard.

14. A non-transitory computer readable medium storing an illumination control program, the illumination control program causing a computer to perform an illumination control process, the illumination control program causing the computer to perform:
acquiring video;
generating an illumination control signal comprising a plurality of sets of illumination control values for controlling illumination based on the acquired video; and
transmitting the generated illumination control signal to one or more illumination instruments at intervals of a predetermined period.

15. The non-transitory computer readable medium according to claim 14, wherein the transmitting of the illumination control signal comprises transmitting the generated illumination control signal to one or more illumination instruments at intervals of a predetermined period which does not depend on at least a frame rate of the video acquired by acquiring the video.

16. The non-transitory computer readable medium according to claim 14, wherein the predetermined period is set based on the illumination instrument to which the illumination control signal is transmitted.

17. The non-transitory computer readable medium according to claim 15, wherein the predetermined period is set based on the illumination instrument to which the illumination control signal is transmitted.

18. An illumination control method comprising:
acquiring video;
generating an illumination control signal comprising a plurality of sets of illumination control values for controlling illumination based on the acquired video; and
transmitting the generated illumination control signal to one or more illumination instruments at intervals of a predetermined period.

19. The illumination control method according to claim 18, wherein the transmitting of the illumination control signal comprises transmitting the generated illumination control signal to one or more illumination instruments at intervals of a predetermined period which does not depend on at least a frame rate of the video acquired by acquiring the video.

20. The illumination control method according to claim 18, wherein the predetermined period is set based on the illumination instrument to which the illumination control signal is transmitted.
